(19) United States
(12) Patent Application Publication
(10) Pub. No.: US 2005/0053451 A1
(43) Pub. Date: Mar. 10, 2005

(54) Vehicle loading and unloading system

(76) Inventors: Pierre Gagnon, Montreal (CA); Pierre Laforest, Montreal (CA); Alain Gobeil, Montreal (CA); Alain Forte, Boucherville (CA)

Correspondence Address: LESPERANCE & MARTINEAU, 1440 WEST, STE-CATHERINE ROOM 700, MONTREAL, QC, H3G1R8, CA

(21) Appl. No.: 10/965,932

(22) Filed: Oct. 18, 2004

Related U.S. Application Data
(63) Continuation-in-part of application No. 10/059,160, filed on Jan. 31, 2002.
Application No. 10/059,160 is a continuation-in-part of application No. 09/501,524, filed on Feb. 9, 2000, now Pat. No. 6,368,042.
(60) Provisional application No. 60/120,407, filed on Feb. 11, 1999.

(51) Int. Cl. B65G 67/00

(52) U.S. Cl. 414/400

(57) ABSTRACT

A loading and unloading system for loading articles into and unloading articles from at least one storage area having an open end and inner side walls. The loading and unloading system includes a powered carriage for carrying articles and having two sides, the distance therebetween defining a carriage width, the carriage also having a front and a rear end and defining a longitudinal axis therebetween. The carriage comprises a main rigid frame movable over ground along the longitudinal axis, a powered article-carrying device mounted to the carriage frame for carrying the articles on the carriage, and a number of lateral guide members mounted to the frame and laterally protruding beyond the frame on both the carriage sides. Moreover, the present system comprises a pair of elongated guiding gates, each gate defining an inner end having a mounting member for movably mounting the gate inner end spacedly from the storage area open end, and an outer free end opposite the inner end, the guiding gates being movable between a retracted position where the gates outer free ends are destined to clear the storage area side walls, and a deployed position where the gates outer free ends are each destined to engage a corresponding one of the storage area side walls. The carriage lateral guide members are for continuous engagement against the guiding gates when the carriage moves between the gates in the deployed position towards and away from the storage area open end, for guiding the carriage towards and away from the storage area during article loading and unloading operations therein.

### CROSS-REFERENCE DATA

The present application is a continuation-in-part application of co-pending U.S. patent application Ser. No. 10/059,160 filed Jan. 31, 2002, which is a continuation-in-part of U.S. patent application Ser. No. 09/501,524 filed on Feb. 9, 2000, which claims priority under the Paris Convention of U.S. provisional patent application No. 60/120,407 filed on Feb. 11, 1999.

### FIELD OF THE INVENTION

The present invention relates to a vehicle loading and unloading system, and more particularly to a system including an automated forklift carriage used for loading and unloading articles into and from transport trucks.

### BACKGROUND OF THE INVENTION

U.S. Pat. No. 4,439,093 issued in 1984 to R. W. Victorino discloses a system for handling palletized articles. This system includes inter alia the step of loading the palletized articles into a conventional semi-trailer truck with a conventional forklift truck, as known in the art. However, it becomes difficult to efficiently load a semi-trailer truck with palletized articles, without unnecessarily losing space inside the truck, and at an efficient speed, without the forklift truck driver accidentally hitting the semi-trailer truck walls with the articles while loading them, considering the often small lateral clearance between the forklift truck loaded with articles and the semi-trailer lateral walls.

Some automated truck loading systems have been developed, such as the one shown in U.S. Pat. No. 4,171,178 issued in 1979 to R. Birkenfeld et al. In this patent, a rail-guided carriage is shown to be used to load a truck from its lateral sides. The rail-guided carriage has the disadvantage of requiring a flawless alignment of the truck relative to the loading dock for loading the articles into the truck in a space-efficient manner. Indeed, should the truck be positioned in a non-parallel relationship with the carriage rails, then the articles will be positioned in a non-parallel fashion relative to the truck walls, and economically valuable space will be wasted inside the semi-trailer. Also, the Birkenfeld patent shows a truck being loaded sidewardly, but it is understood that it is more complex and it requires more precision for a carriage to be aligned relative to the rear opening of a conventional rearwardly-opened semi-trailer truck such as the one shown in the above-mentioned Victorino patent, than it is for a carriage to be aligned with the often wider side openings of laterally loaded trucks such as the one shown in the Birkenfeld patent. Also, conventional merchandise semi-trailers are more often provided with a rear opening, so the Birkenfeld system is not representative of the most likely type of truck encountered.

### SUMMARY OF THE INVENTION

The present invention relates to a loading and unloading system for loading articles into and unloading articles from at least one storage area having an open end and inner side walls, said loading and unloading system including:
a carriage for carrying articles, said carriage having two sides, the distance between said two sides defining a carriage width, said carriage also having a front and a rear end and defining a longitudinal axis therebetween, said carriage comprising:
   a main rigid frame movable over ground at least along said longitudinal axis,
   a motor for feeding power to and driving said carriage along said longitudinal axis,
   a powered article-carrying device mounted to said carriage frame for carrying the articles on said carriage, and
   a number of lateral guide members mounted to said frame and laterally protruding beyond said frame on both said carriage sides, and
a pair of elongated guiding gates, each said gate defining an inner end having a mounting member for movably mounting said gate inner end spacedly from the storage area open end, and an outer free end opposite said inner end, said guiding gates being movable between a retracted position where said gates outer free ends are destined to clear the storage area side walls, and a deployed position where said gates outer free ends are each destined to engage a corresponding one of the storage area side walls, and where the distance between said guiding gates inner ends is at least equal to said carriage width and the distance between said guiding gates outer ends is also at least equal to said carriage width;
   wherein said carriage lateral guide members are for continuous engagement against said guiding gates when said carriage moves between said gates in said deployed position towards and away from the storage area open end, for guiding said carriage towards and away from the storage area during article loading and unloading operations therein.

In one embodiment, said inner end of each said gate is destined to be pivotally attached to a ground surface such that said pair of gates faces the storage area, each said gate being pivotable about a vertical axis intersecting said inner end thereof, between said retracted position in which each said gate is destined to be pivoted away from the storage area and said outer free end of each said gate clears the storage area side walls, and said deployed position where said gates are destined to be pivoted towards said storage area and said outer free end of each said gate engages a corresponding storage area side wall.

In one embodiment, said carriage further comprises a linkage pivotally attached to said carriage main frame, carrying and interconnecting said guide members and forcing said guide members into an integral common displacement relative to said frame so that they remain symmetrically disposed relative to said longitudinal axis at all times, said guide members being movable relative to said frame between an inner limit position toward said frame and an outer limit position away from said frame, said carriage also comprising a biasing member mounted to said frame and continuously biasing said guide members through the instrumentality of said linkage towards said outer limit position, wherein said carriage is adapted for self-alignment and self-centering between either one of said gates in said deployed position and the side walls of the storage area, by said guide members continuously engaging either one of said gates and the side walls of the storage area and by said linkage and said biasing member forcing said guide members to remain symmetrically disposed relative to said longitudinal axis.

In one embodiment, the loading and unloading system further comprises a bogie, able to carry said carriage and movable along a bogie horizontal axis transverse to said carriage longitudinal axis, said bogie comprising a motor for feeding power to and moving said bogie along said bogie horizontal axis, and a platform for receiving and supporting said carriage thereon and defining two sides and front and rear end portions, said bogie being destined to be movable between multiple storage areas to allow said carriage to load articles onto and unload articles from different storage areas.

In one embodiment, said guiding gates are pivotally mounted on each said side of said bogie at said bogie front end portion, said gates vertically registering with said carriage guide members and being pivotable between said retracted position in which they are pivoted towards said bogie front end portion, and said deployed position in which said gates are pivoted away from said bogie front end portion for engaging said storage area.

In one embodiment, said bogie is provided with an actuator for actuating said gates between said retracted and deployed positions.

In one embodiment, said carriage further comprises a linkage pivotally attached to said carriage frame, carrying and interconnecting said guide members and forcing said guide members into an integral common displacement relative to said frame so that they remain symmetrically disposed relative to said longitudinal axis at all times, said guide members being movable relative to said frame between an inner limit position toward said frame and an outer limit position away from said frame, said carriage also comprising a biasing member mounted to said frame and continuously biasing said guide members through the instrumentality of said linkage towards said outer limit position, wherein said carriage is adapted for self-alignment and self-centering between either one of said gates in said deployed position and the side walls of the storage area, by said guide members continuously engaging either one of said gates and the side walls of the storage area and by said linkage and said biasing member forcing said guide members to remain symmetrically disposed relative to said longitudinal axis.

In one embodiment, said bogie comprises two parallel railings each fixedly attached to a corresponding said side of said bogie, said railings vertically registering with said guide members, said guide members continuously engaging said railings while said carriage is located between said railings for self-aligning and self-centering said carriage on said bogie due to said spring member and said linkage, said railings being co-extensive and substantially collinear relative to said gates when said gates are in said deployed position, for providing a continuous guiding track formed on both sides of said carriage by said railings, said gates and the storage area side walls, for continuous engagement of said carriage guide members on said guiding track when said carriage moves between said bogie and the storage area, said carriage thus being self-aligned and self-centered relative to said railings, said gates and the storage area side walls during its displacements between said bogie and the storage area during article loading and unloading operations.

In one embodiment, said guide members are idle guide wheels, with said linkage rollably carrying said idle guide wheels, wherein said carriage is adapted for self-alignment and self-centering between said railings, between said gates and between the storage area side walls by said guide wheels continuously rollably engaging same and by said linkage and said biasing member forcing said guide wheels to remain symmetrically disposed relative to said carriage frame at all times.

In one embodiment, the loading and unloading system further comprises two anti-spill panels, each fixedly mounted atop a corresponding one of said guiding gates, for preventing articles carried on said carriage article-carrying device from tumbling off therefrom when said carriage moves between said bogie and the storage area open end. In one embodiment, the loading and unloading system further comprises a control unit for automatically controlling the displacement of said bogie along said bogie horizontal axis, the displacement of said carriage along said longitudinal axis, and the pivotal displacement of said gates.

In one embodiment, said control unit can adjust the position of said bogie along said horizontal bogie axis when said gates are in said deployed position, according to the relative position of said gates, for selectively positioning said bogie relative to the storage area side walls.

In one embodiment, the loading and unloading system further comprises a conveyor for conveying articles and located frontwardly of said bogie, wherein said carriage is destined to carry the articles with said article-carrying device from said conveyor into the storage area for unloading them therein.

In one embodiment, said powered article-carrying device is a powered hydraulic forklift member located at said carriage front end.

In one embodiment, said conveyor is an overhead conveyor located spacedly above ground, said carriage carrying the articles being destined to move underneath said overhead conveyor and to reach the articles on the conveyor with said forklift member.

In one embodiment, said control unit further automatically controls said conveyor, for positioning the articles thereon in a precise centered relationship relative to said bogie.

The present invention also relates to a guiding system for use with a carriage capable of loading articles in and unloading articles from a storage area, said guiding system comprising a pair of elongated guiding gates each defining a first end having a mounting member for movably mounting said gate spacedly from the storage area, and a second free end opposite said first end, said gates being movable between a retracted position in which said second ends of said gates are destined to clear the storage area, and a deployed position in which said second ends of said gates are destined to engage an abutment member within the storage area, said guiding system further comprising a selectively powered actuator for moving said gates between said retracted and deployed positions, wherein said gates will define a path therebetween when in said deployed position for guiding the carriage to and from the storage area by the abutment of the carriage along said gates.

In one embodiment, said mounting members are pivotable mounts, whereby said gates are pivotable between said retracted and deployed positions.

### DESCRIPTION OF THE DRAWINGS

In the annexed drawings:

FIG. 1 is a perspective view of a loading dock, with the adjacent wall being broken away for showing the inner components of the loading station registering with the loading dock, FIG. 1 further showing the rear portion of a semi-trailer positioned so as to register with the loading dock and loading station, and the carriage-carrying bogie moving towards the loading station;

FIG. 2 is a perspective view similar to FIG. 1, although at a slightly different angle, wherein the carriage-carrying bogie is aligned with the loading station, wherein the pivotable alignment gates are in a partly opened position and wherein palletized articles to be loaded into the semi-trailer are located on the overhead conveyor of the truck loading station;

FIGS. 3 to 6 are side elevations of the elements shown in FIG. 2, sequentially illustrating the steps of the articles being loaded into the semi-trailer;

FIG. 7 is a perspective view of the carriage-carrying bogie of the invention, with the pivotable gates being shown in an opened condition;

FIGS. 8 and 9 are respectively a perspective view and a top plan view of the automated carriage of the invention;

FIG. 10 is a perspective view of the frame structure and of the spring-loaded alignment linkage of the carriage of the invention;

FIG. 11 is a top plan view of the spring-loaded alignment linkage of the carriage according to the invention;

FIG. 12 shows an alternate embodiment of the present invention in a view similar to that of FIG. 2, but where the pivotable alignment gates are each provided with an anti-spill panel; and

FIG. 13 shows yet another alternate embodiment of the present invention in a view similar to that of FIG. 2, but where the pivotable alignment gates are installed on the floor rather than on the bogie.

### DETAILED DESCRIPTION OF THE EMBODIMENTS

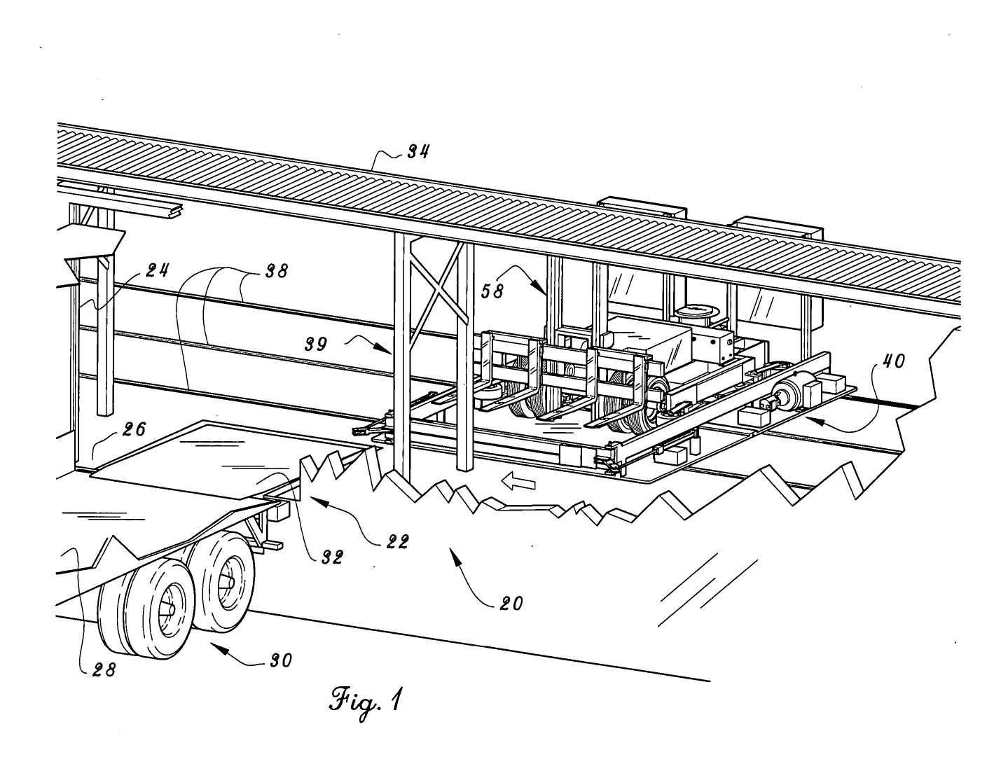

FIG. 1 shows a loading station 20 including a loading dock 22 defined by an opening 24 in a wall of a building and a floor portion 26 which is substantially at a same height as the flooring 28 of a semi-trailer 30 which registers with loading station 20. As known in the art, a pivotable panel 32 hingedly attached to dock floor 26 bridges the dock floor 26 and the semi-trailer floor 28 and acts as a ramp to compensate any vertical offset between dock floor 26 and semi-trailer floor 28.

In the description hereinafter, reference will be made to the loading of articles into semi-trailer 30, although it is understood that the unloading of articles therefrom could be accomplished by reversing the steps accomplished to load the semi-trailer 30. Also, although a semi-trailer conventionally used with a truck is shown, it is understood that loading and unloading of articles with the system according to the present invention could be accomplished onto other vehicles or storage areas.

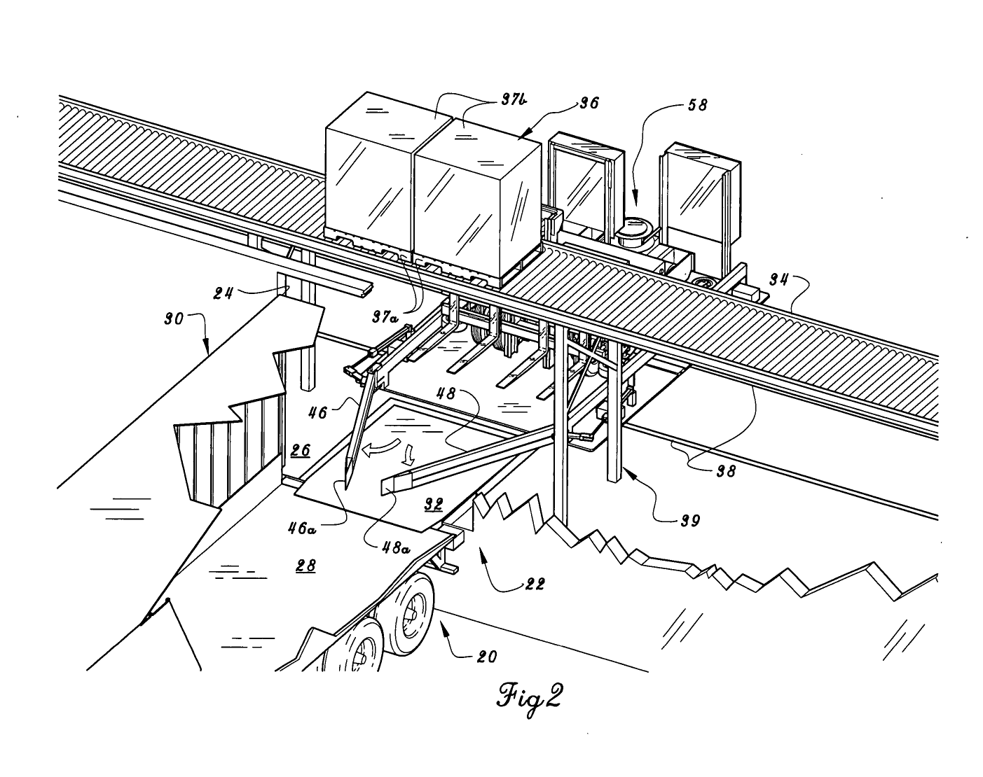

FIGS. 1 and 2 show that loading station 20 further includes an overhead conveyor 34 of conventional construction, which is destined to convey palletized articles 36 to loading station 20, i.e. in general register with dock 22, as will be detailed hereinafter. Conveyor 34 runs parallel to dock opening 24 and vertically clears same by the support of spaced-apart upright posts 39 which horizontally clear opening 24. Palletized articles 36 include two pallets 37a supporting boxed goods 37b.

A set of three rails 38 are fixedly installed on the floor parallel to the dock opening 24, so as to carry a bogie 40 movable along rails 38 between loading station 20 and other similar loading stations (not shown). Rails 38 run parallel to conveyor 34, and thus bogie 40 is movable parallel to and along conveyor 34, as suggested in FIG. 1. To load articles 36 into semi-trailer 30, bogie 40 is initially automatically positioned in centered register with dock opening 24, as shown in FIG. 2. Also, conveyor 34 moves to align articles 36 with bogie 40, and thus articles 36 and bogie 40 are always aligned relative to each other through electronic control devices (not shown).

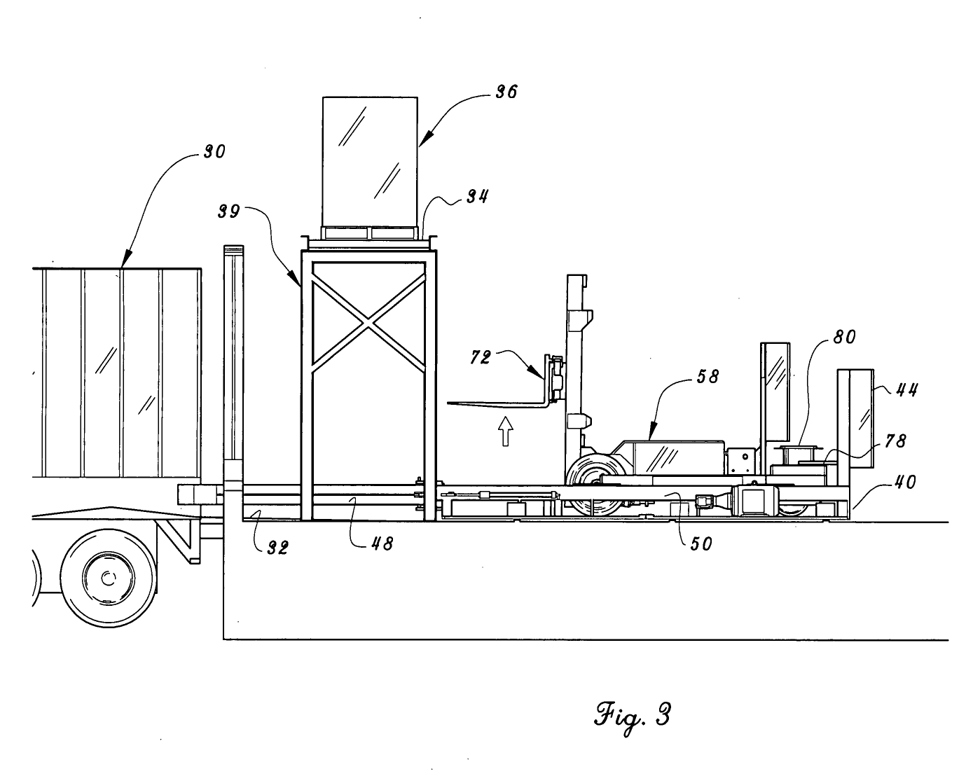

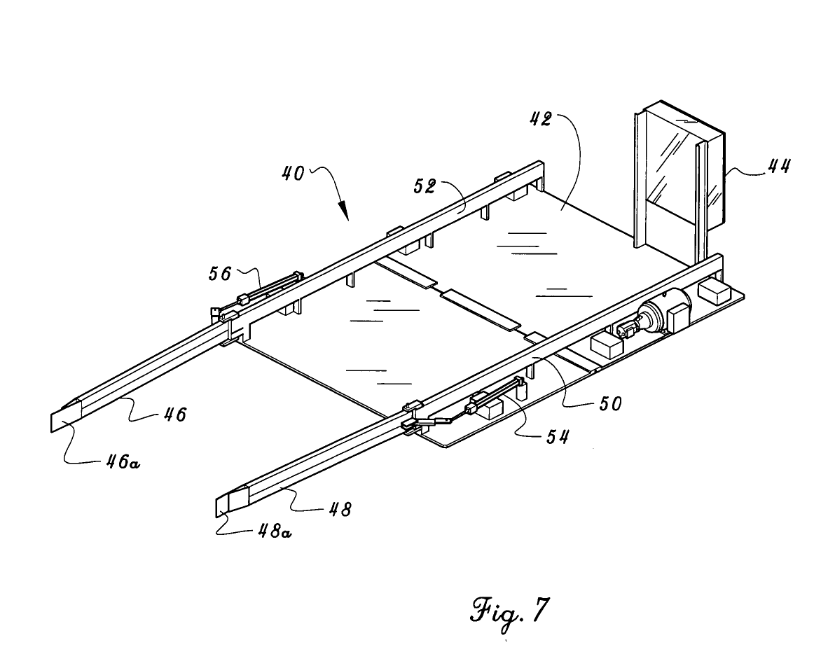

Bogie 40 is shown in FIG. 7, and includes a rigid, flat platform 42 and a rearwardly positioned control panel 44 which allows the controller to selectively move bogie 40 along rails 38 and which further allows the controller to selectively pivot frontwardly located alignment or guiding gates 46, 48 between a closed condition (shown in FIG. 1), through an intermediate partly opened condition (shown in FIG. 2) into an opened condition (shown in FIGS. 3-7). In their opened condition, gates 46, 48 become substantially coextensive with fixed lateral railings 50, 52 provided on each side of bogie 40, to form elongated alignment gate members having substantially flat inner surfaces for example. Moreover, the gates 46, 48 are sized to extend with their outer free end portions slightly beyond dock opening 24 when they are in their opened condition, so as to be engageable with their outer free tips 46a, 48a against the lateral inner walls of the truck semi-trailer 30 and become co-extensive and substantially collinear therewith. As shown in FIG. 7, hydraulic rams 54, 56 are used to control the pivotal displacement of gates 46, 48; however, any other suitable actuator could be used instead of hydraulic rams to actuate the pivotal displacement of gates 46, 48.

A forklift carriage 58 is provided on bogie 40, as shown in FIGS. 1-6 and 8-11.

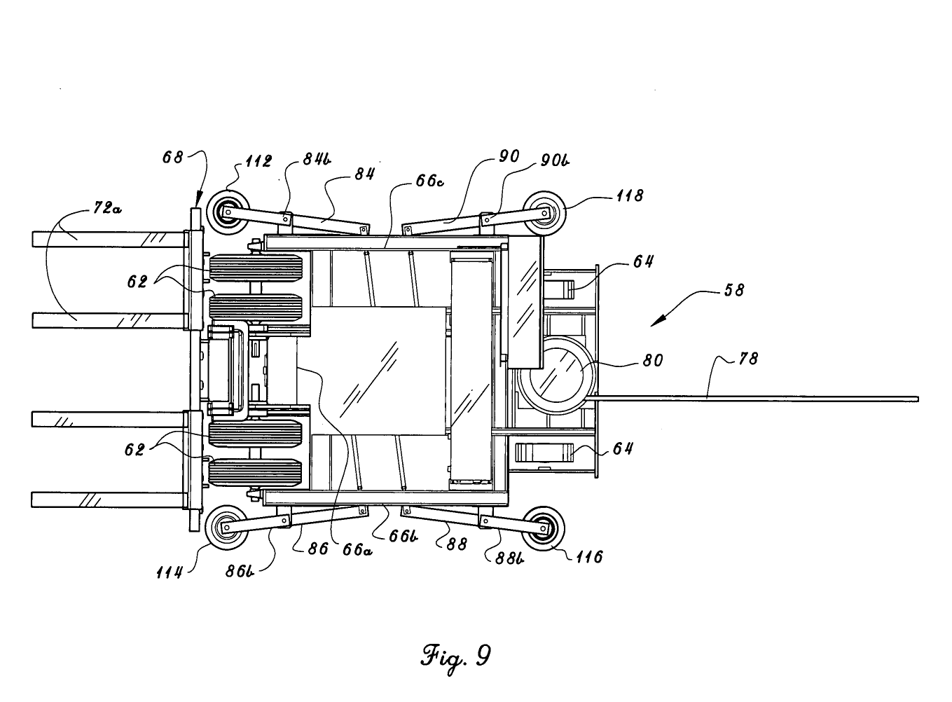

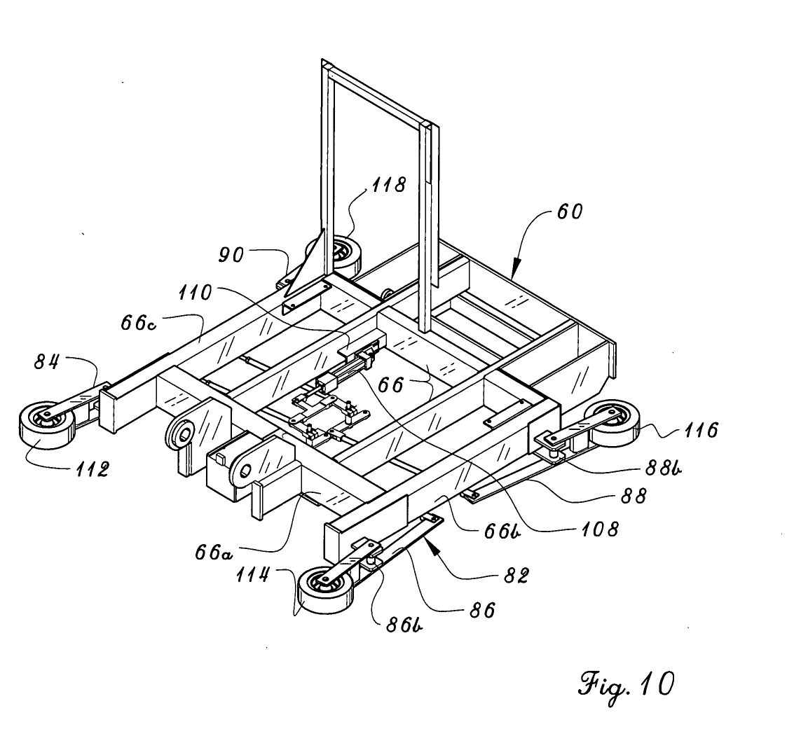

Carriage 58 comprises a frame structure 60 supported over ground by a number of front and rear support wheels 62 and 64 respectively, with front support wheels 62 being larger since they will support the main load of palletized articles 36 when temporarily transported by carriage 58, as described hereinafter. Frame 60 has a number of perpendicularly arranged bars 66 to form a rigid structure, including a frontmost bar 66a supporting a forklift structure 68 and lateral bars 66b, 66c (FIGS. 9-10).

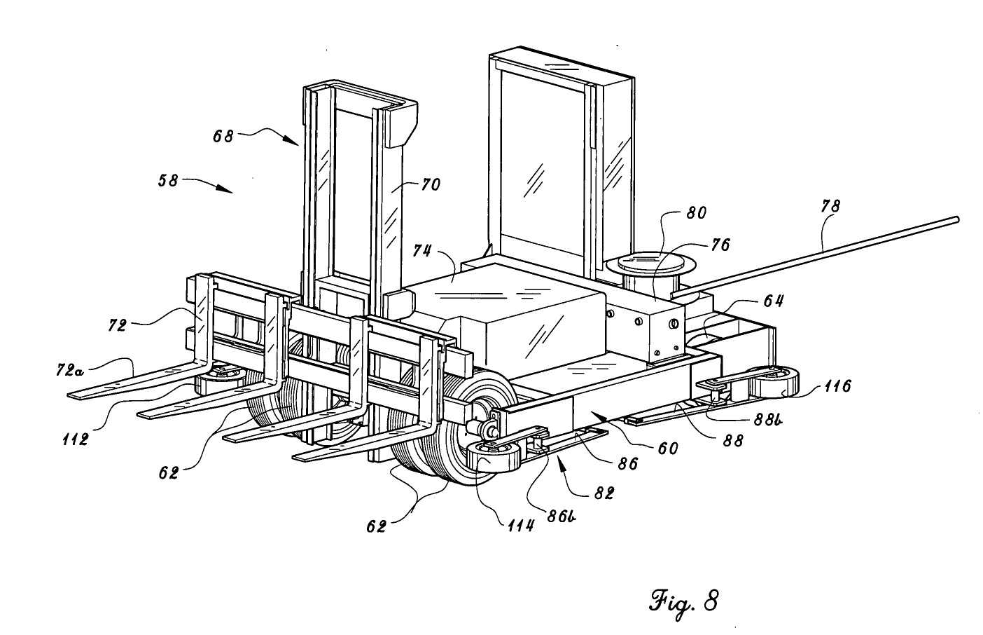

Forklift structure 68 includes a vertically disposed track member 70 fixedly attached to frontmost bar 66a of frame 60, along which a fork member 72, e.g. including four forks 72a as shown in the drawings, is vertically movable under the selectively activated bias of an actuation member in the form of a hydraulic cylinder (not shown). The fork member 72 and track member 70 assembly is of known construction, and is actuated by know means. Frame 60 further supports a casing 74 enclosing the motor elements of carriage 58, and a hydraulic fluid reservoir 76 for feeding the hydraulic cylinder allowing the vertical movement of fork member 72. A wire 78 power feeds the carriage motor, wire 78 being linked to the bogie control panel 44 as shown in FIGS. 3-6. FIGS. 8-9 further show that a spring-loaded rotatable spool 80 is provided at the rear end portion of carriage 58, on frame 60, with the wire 78 being wound around spool 80 so that wire 78 remain tensioned over ground between carriage 58 and control panel 44 while being long enough to be unrolled and allow movement of carriage 58 away from and back towards control panel 44. A carriage control panel 81 is carried at the rear end of frame 60.

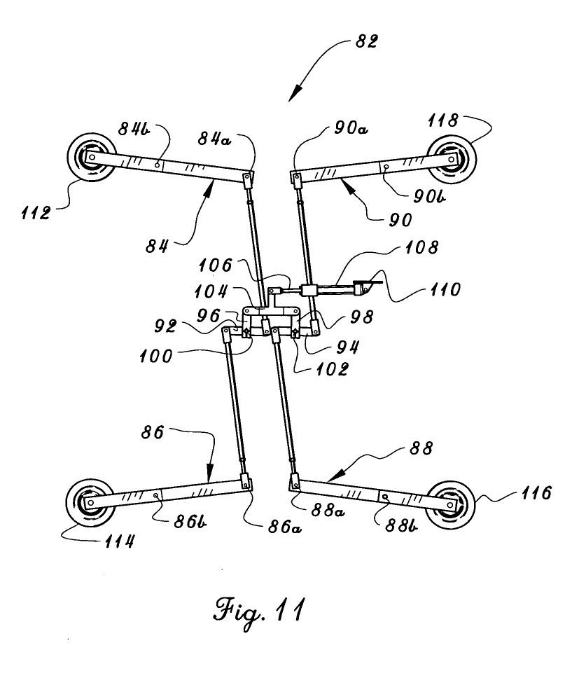

Carriage 58 is further provided with a spring-loaded linkage 82 which is located under and attached to frame 60. Linkage 82 is independently shown in FIG. 11, but can be seen also in FIGS. 8-10. More particularly, linkage 82 comprises four elbowed L-shaped links 84, 86, 88, 90 which are each pivotable at their respective elbows 84a, 86a, 88a, 90a and which are pivotally linked by pairs with short rods 92, 94 centrally under frame 60, i.e. rear links 88, 90 are pivotally attached to rear rod 94, and front links 84, 86 are pivotally attached to front rod 92. Rods 92, 94 are in turn centrally integrally attached to the end portions of intermediate plates 96, 98 at 100, 102, with pivots 100, 102 being pivotally mounted to the frame 60 (not shown in FIG. 10). Thus, rod 92 and plate 96 are forced into integral pivotal displacement about pivot 100, as are rod 94 and plate 98 about pivot 102. Intermediate plates 96, 98 are pivotally attached to the two opposite ends of a T-shaped plate 104, which is in turn pivotally attached to the outer extremity of the movable rod 106 of a hydraulic cylinder 108 fixedly attached at its base to frame 60 at 110. Links 84, 86, 88, 90 are each pivotally attached to the carriage main frame 60 at 84b, 86b, 88b, 90b, and support horizontally disposed idle guide wheels 112, 114, 116, 118 at their outer free ends.

Thus, due to the interconnection of the different links, bars and rods of linkage 82, and to the fact that linkage 82 is only pivotally attached to frame 60 at 84b, 86b, 88b, 90b, at 100, 102 and at 110, guide wheels 112, 114, 116, 118 are integrally linked in their movements by linkage 82, i.e. if one wheel such as wheel 112 is forced inwardly, then all other wheels 114, 116, 118 will also be forced to pivot inwardly of a same distance. Guide wheels 112, 114, 116, 118 thus pivot in a common symmetrical motion, relative to frame 60, from an outer limit position to an inner limit position. Hydraulic cylinder 108 continuously biases wheels 112, 114, 116, 118, by means of linkage 82, towards said outer limit position.

Wheels of a same side, i.e. wheels 112 and 118 and wheels 114 and 116, are longitudinally aligned, and each pair of longitudinally aligned wheels 112, 118 and 114, 116 laterally protrudes beyond all other structural elements of carriage 58, even when wheels 112, 114, 116, 118 are pivoted into their inner limit position.

In use, to load palletized articles 36 into a semi-trailer 30, bogie 40 is moved along rails 38 towards loading station 20 as shown in FIG. 1, until it becomes aligned in facing register and centered with dock 22 as shown in FIG. 2. Automated cue means then trigger the controls of bogie 40 to immobilize it at this position, bogie 40 then also being in facing register with articles 36 since the latter, as stated hereinabove, are centrally aligned relative to bogie 40 by conveyor 34. The bogie gates 46, 48 are then pivoted towards their opened condition as also shown in FIG. 2, until they abut against the side walls of the semi-trailer 30 with their tips 46a, 48a. Gates 46, 48, in their opened condition, cooperate with co-extensive and approximately collinear railings 50, 52 of bogie 40, and with the inner lateral walls of the semi-trailer 30, to provide a continuous guiding track for guiding the displacements of carriage 58 between platform 42 of bogie 40 and the inner storage area of semi-trailer 30.

The rear opening of semi-trailer 30 has been positioned in approximate facing register with dock 22 by a truck driver, but slight positional deviations of semi-trailer 30 relative to dock 22 can and in practice do occur. Indeed, it is likely that the semi-trailer 30 may not be exactly perpendicular to the dock opening 24 and/or not exactly centered relative to the dock opening 24, and thus a slight angular deviation of gates 46, 48 in their opened condition relative to railings 50, 52 is possible, since their outer free tips 46a, 48a abut against the misaligned semi-trailer opening. Also, depending on the width of the semi-trailer 30 opening, gates 46, 48 may be disposed in a parallel or in a more or less convergent or divergent fashion. However, railing 50 forms a continuous gate member with gate 48, as does railing 52 with gate 46, albeit not necessarily a straight one, which results in the “substantially” collinear relationship.

Once gates 46, 48 are in their opened condition, detection devices (not shown) on bogie 40 assess the pivotal position of gates 46, 48, and according to the value of the respective angles formed between railings 50, 52 and gates 46, 48 respectively, the latter abutting with their tips 46a, 48a against the semi-trailer 30 rear opening, control device 44 controls bogie 40 to move so as to center itself relative to the semi-trailer 30 rear opening. In one embodiment, control device 44, which controls the displacement of bogie 40 along rails 38, considers bogie 40 to be centered relative to semi-trailer 30 rear opening when the angle formed between gate 46 and railing 52, and the angle formed between gate 48 and railing 50, have equal values. Conveyor 34 then also moves consequently to align palletized articles 36 with the corrected position of bogie 40 by means of electronic cue means.

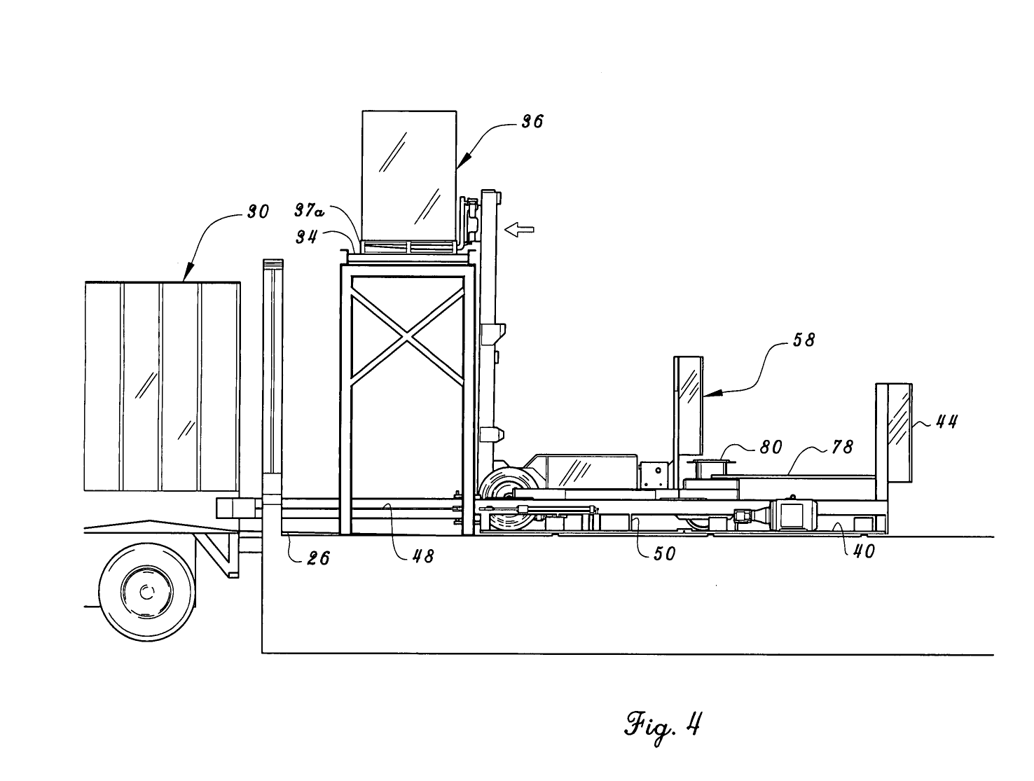

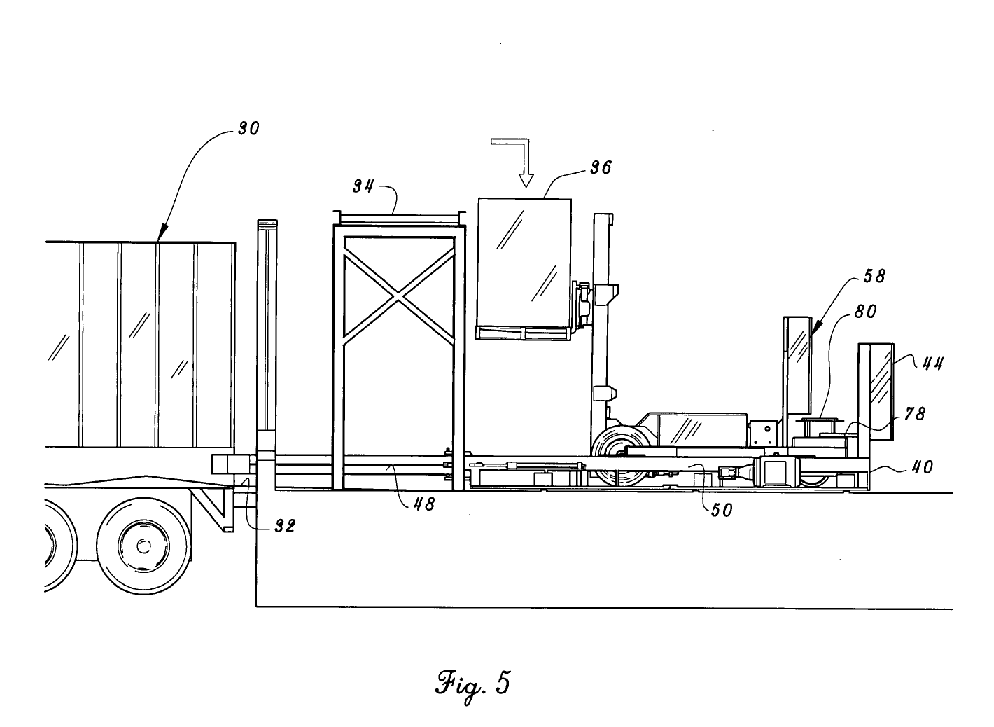

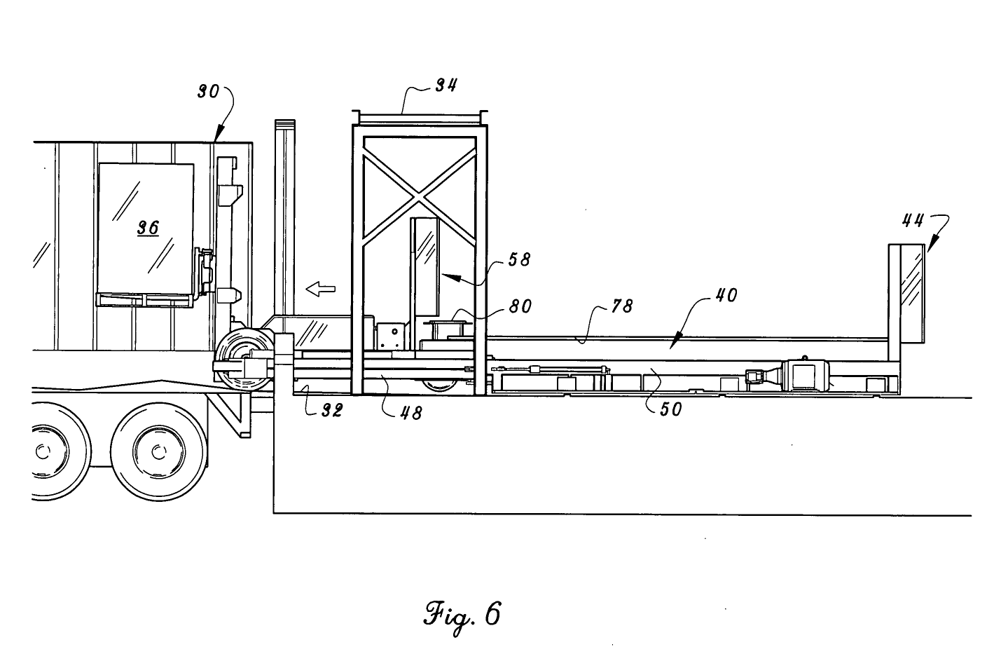

The fork member 72 of forklift carriage 58 is then raised, as shown in FIG. 3, and carriage 58 moved forward as shown in FIG. 4 so that fork member 72 engage in a known manner the pallets 37a of palletized articles 36 located on overhead conveyor 34. Since palletized articles 36 are symmetrically aligned relative to bogie 40, articles are thus loaded on fork member 72 in a centered manner. As shown in FIG. 5, articles 36 are then retrieved by carriage 58 which moves rearwardly and then lowers its fork member 72. Carriage 58 finally moves forward into semi-trailer 30 as shown in FIG. 6 to unload the articles 36 therein. As shown in the drawings, the height of conveyor 34 is greater than that of dock opening 24, and thus the articles 36, destined to fit into a semi-trailer 30 and thus to also fit through dock opening 24, will vertically fit under conveyor 34.

According to the invention, the spring-loaded alignment linkage 82 allows carriage 58 to self-align and remain centered while it moves forward and backward between the railings 50, 52, the gates 46, 48 and into the semi-trailer 30. Indeed, the carriage guide wheels 112, 114, 116, 118 are continuously forced outwardly under the bias of hydraulic cylinder 108, and continuously engage in their initial position the railings 50, 52 of bogie 40. When carriage 58 moves forward towards semi-trailer 30, its guide wheels 112, 114, 116, 118 will continuously engage the continuous guiding track formed sequentially by railings 50, 52, gates 46, 48 and the inner side walls of the semi-trailer 30. Moreover, the force exerted by hydraulic cylinder 108 will force guide wheels 112, 114, 116, 118 to remain symmetrically disposed relative to frame 60 as carriage 58 advances, thereby effectively centering the carriage 58 during its path towards and into the semi-trailer 30.

Consequently, even if the semi-trailer is not perfectly centered or angularly oriented relative to the dock 22, the guide wheels 112, 114, 116, 118 in combination with the spring-loaded linkage 82, will ensure that carriage 58 enters the semi-trailer 30 in a correctly aligned and centered fashion. This is why carriage 58 is said to be self-aligning.

It can be seen that the system according to the present invention can be used with semi-trailer trucks 30 of different widths. Indeed, if the semi-trailer is narrower, then the gates 46, 48 will abut against the semi-trailer side walls in a slightly convergent fashion, with the spring-loaded linkage 82 and the idle guide wheels 112, 114, 116, 118 compensating for the narrower path along which carriage 58 must advance by being contracted by the converging gates.

In one embodiment, the lateral offset between the pairs of longitudinally aligned wheels at the wheels outer limit position will be equal to or wider than the wider dimensions of semi-trailer trucks, and the angular deflections of linkage 82 will allow the pairs of longitudinally aligned wheels 112, 118 and 114, 116 to become at least as narrow as the narrower dimensions of semi-trailer trucks. For example, in North America, the width of conventional semi-trailers varies between approximately 94 inches (240 centimeters) and 102 inches (260 centimeters).

Thus, the angular deflection of guide wheels 112, 114, 116, 118 would allow the width of the longitudinally aligned pairs of guide wheels 112, 118 and 114, 116 to vary at least between the above-mentioned dimensions, so that carriage 58 would operatively fit into semi-trailers of all conventional dimensions. Of course, dimensional adjustments may be envisioned on linkage 82, to fit trucks and storage areas of varying sizes, the above dimensions being provided as examples.

It is noted that with the system according to the present invention, loading of articles into semi-trailer 30 may be accomplished automatically, without any human intervention, after the operation is initiated. Indeed, the following sequential steps are automatically accomplished by the system according to the present invention:
a) initial positioning of bogie 40 in centered relationship with dock opening 24;
b) opening of gates 46, 48 until they abut against the semi-trailer 30 rear opening;
c) positional rectification of bogie 40 for centered alignment with the semi-trailer 30 storage area to reach a symmetrical angular relationship of gates 46, 48;
d) articles 36 are conveyed by conveyor 34 until they come in centered alignement with bogie 40 in its corrected position;
e) loading of palletized articles 36 onto carriage 58;
f) unloading of articles 36 from carriage 58 into the semi-trailer 30 storage area by carriage 58; and
g) return of carriage 58 to bogie 40;
   where steps (d) to (g) may be repeated a number of times to load numerous palletized articles into semi-trailer 30, with the orientation of carriage 58 being corrected accordingly, if semi-trailer 30 is angularly offset relative to the loading station 22, by the action of the idle wheels 112, 114, 116, 118 and of linkage 82. The control units for controlling the displacements and movements of bogie 40, carriage 58 and conveyor 34 can be located in control panels 44 and 81.

Any further modification to the present invention, which does not deviate from the scope thereof, is considered to be included therein.

For example, it could be envisioned to provide a system according to the present invention which would comprise a single loading station, and consequently in which the transversely moving bogie would not be required.

Also, article-carrying devices other than forklift members could be used.

The hydraulic cylinder 108 used to force idle guide wheels 112, 114, 116, 118 towards their outer limit position, could be replaced by any suitable spring member.

Alternate guiding members could be used instead of guide wheels, such as suitable sliding elements, e.g. small skis made of a sliding material such as nylon.

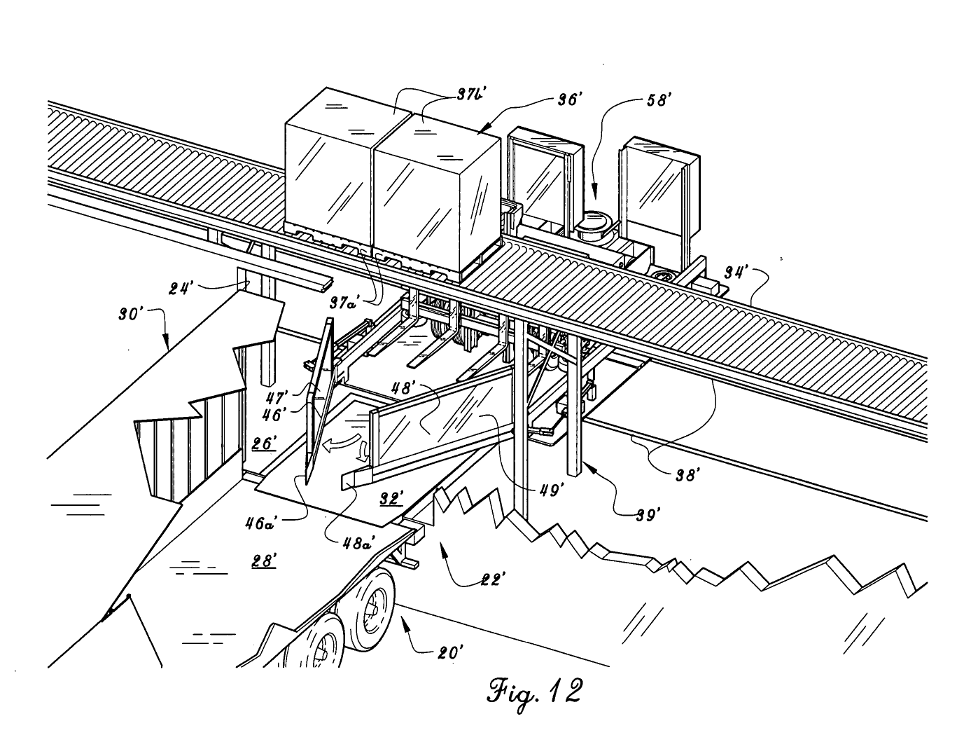

FIG. 12 shows another embodiment of the invention where primed reference numbers refer to similar structures having the same non-primed reference numbers in the first embodiment shown in FIGS. 1-11. In this embodiment, generally rectangular anti-spill panels 47′, 49′ are installed directly atop gates 46′, 48′. Panels 47′, 49′ help prevent articles such as boxes (for example) from tumbling laterally off the pallet on which they are loaded, while being transported by carriage 58′ in or out of the storage area of the semi-trailer. Lateral panels 47′, 49′ are especially advantageous since they allow a carriage to load articles that span substantially the entire width of the semi-trailer without these articles accidentally engaging the outer peripheral edge of the semi-trailer rear opening during the loading operation. Indeed, it is understood that it is desirable to maximize the volume of the semi-trailer by loading as many articles therein as possible, to increase the profitability of a semi-trailer trip. However, loading a semi-trailer with articles stacked on pallets may result in the articles laterally tumbling off from the pallets and out of the loading area if the articles accidentally abut against the outer peripheral edge of the semi-trailer rear opening. This is especially true since stacks of articles being conveyed by a carriage such as carriage 58, 58′ or a conventional forklift truck will often move slightly and protrude laterally from their preferred vertical stacked position. In conventional systems, this problem is addressed by stacking less articles to provide a stack of articles that will have a width spanning significantly less than the width of the semi-trailer storage area, thus effectively providing a widthwise play on each side of the articles as they are loaded within the semi-trailer storage area. Although this reduces the risk of having articles engaging the outer peripheral edge of the semi-trailer rear opening, this will result in such accidents still occurring, and in any event this will also result in loss of article space within the storage area due to the presence of this widthwise play.

With the panels 47′, 49′ of the invention, on the other hand, articles accidentally tilting on one side or the other will be retained and slidably guided by their abutment on panels 47′, 49′ towards the semi-trailer storage area as carriage 58′ moves forward. Since the outer free tips 46a′, 48a′ of gates 46, 48 abut against the inner surface of storage area walls, the articles will be guarded against any accidental engagement against the outer peripheral edge of the semi-trailer rear opening, and will effectively be prevented from accidentally tumbling off their stack on the carriage forklift and spilling out on the ground.

It is further noted that, in one embodiment, the pivotal mounts of gates 46′, 48′ will be spaced apart of a greater width than that of the semi-trailer storage area, so as to form a convergent channel between the bogie 40′ and the semi-trailer 30′. Consequently, the articles will be funneled towards the semi-trailer as they are carried by carriage 58′. Also, this spaced-apart position of the pivotal mounts of gates 46′, 48′ helps prevent that the articles accidentally abut against the inner edges of panels 47′, 49′. To further ensure that the articles will be properly funneled, it is also envisioned to provide parallel side walls (not shown) extending vertically over lateral railings 50′, 52′ of bogie 40′, that would be substantially coextensive with panels 47′, 49′ when the gates are in their opened condition to provide elevated side panels all along the path of carriage 58′.

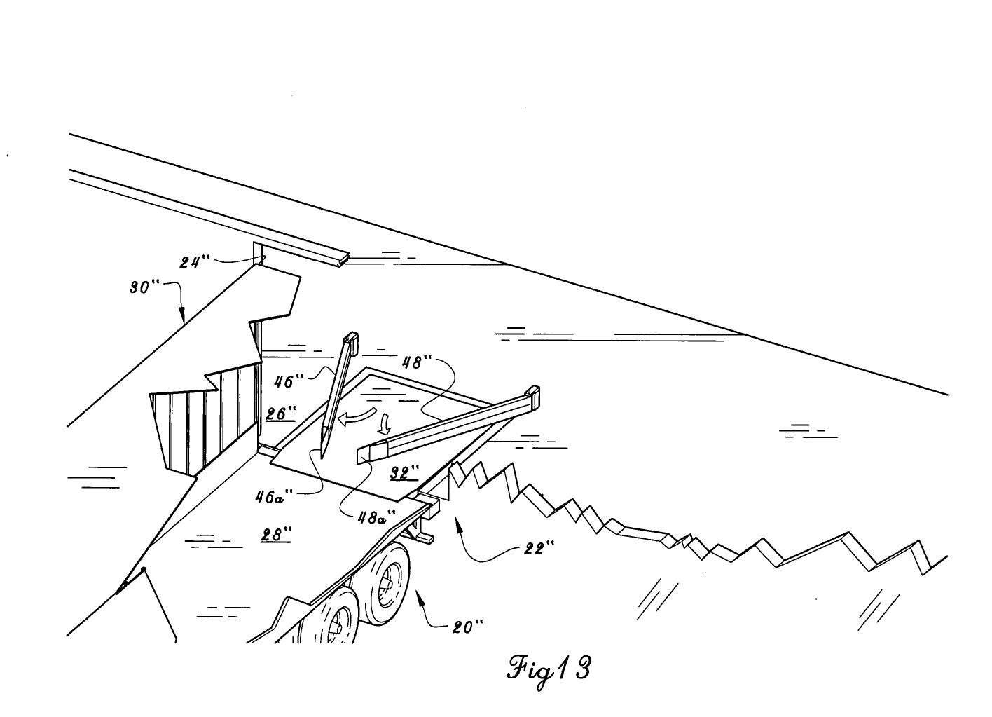

FIG. 13 shows yet another embodiment of the present invention, where double-primed reference numbers refer to similar structures having the same non-primed reference numbers in FIGS. 1-11. In this embodiment, gates 46″, 48″ are installed directly on floor portion 26″ instead of being provided on a bogie. Gates 46″, 48″ are pivotally attached to the floor so as to face dock opening 24″, and are each pivotable about a vertical axis intersecting their pivotal attachment to the floor.

This embodiment would allow the use of alternate article-handling vehicles instead of a bogie-borne carriage such as that shown in FIGS. 1-12. For example, a third-party Automatic Guided Vehicle (AGV), as known in the art and as commonly used for pallet-handling applications, can be used as an article-handling vehicle to replace the bogie-borne carriage of FIGS. 1-12. An AGV consists in a computer-controlled vehicle, normally battery-powered, that runs on the warehouse floor without the need for an onboard driver. AGVs have defined paths or areas along which they can navigate. Navigation is achieved by any one of several means, including following a path defined by buried inductive wires, surface mounted magnetic or optical strips; or alternatively by way of inertial or laser guidance.

An AGV meant to be used in combination with the present invention would be provided with lateral guiding members, such as the guiding wheels 112, 114, 116, 118 provided on carriage 58 as defined in the present invention. In use, the AGV would automatically find its way between floor-attached gates 46″, 48″, previously deployed such that their outer free tips 46a″, 48a″ abut against the inner lateral walls of the semi-trailer 30″, and the AGV would move towards and within the semi-trailer storage area while its lateral guiding members engage and follow the continuous guiding track formed by gates 46″, 48″ and the inner side walls of the semi-trailer 30″, in order for the AGV to be guided towards and within the semi-trailer 30 storage area. Gates 46a″, 48a″ would consequently form a funnel guiding the AGV towards and into the semi-trailer storage area.

1. A loading and unloading system for loading articles into and unloading articles from at least one storage area having an open end and inner side walls, said loading and unloading system including:
a carriage for carrying articles, said carriage having two sides, the distance between said two sides defining a carriage width, said carriage also having a front and a rear end and defining a longitudinal axis therebetween, said carriage comprising:
a main rigid frame movable over ground at least along said longitudinal axis,
a motor for feeding power to and driving said carriage along said longitudinal axis,
a powered article-carrying device mounted to said carriage frame for carrying the articles on said carriage, and
a number of lateral guide members mounted to said frame and laterally protruding beyond said frame on both said carriage sides, and
a pair of elongated guiding gates, each said gate defining an inner end having a mounting member for movably mounting said gate inner end spacedly from the storage area open end, and an outer free end opposite said inner end, said guiding gates being movable between a retracted position where said gates outer free ends are destined to clear the storage area side walls, and a deployed position where said gates outer free ends are each destined to engage a corresponding one of the storage area side walls, and where the distance between said guiding gates inner ends is at least equal to said carriage width and the distance between said guiding gates outer ends is also at least equal to said carriage width;
wherein said carriage lateral guide members are for continuous engagement against said guiding gates when said carriage moves between said gates in said deployed position towards and away from the storage area open end, for guiding said carriage towards and away from the storage area during article loading and unloading operations therein.

2. A loading and unloading system as defined in claim 1,
wherein said inner end of each said gate is destined to be pivotally attached to a ground surface such that said pair of gates faces the storage area, each said gate being pivotable about a vertical axis intersecting said inner end thereof, between said retracted position in which each said gate is destined to be pivoted away from the storage area and said outer free end of each said gate clears the storage area side walls, and said deployed position where said gates are destined to be pivoted towards said storage area and said outer free end of each said gate engages a corresponding storage area side wall.

3. A loading and unloading system as defined in claim 2,
wherein said carriage further comprises a linkage pivotally attached to said carriage main frame, carrying and interconnecting said guide members and forcing said guide members into an integral common displacement relative to said frame so that they remain symmetrically disposed relative to said longitudinal axis at all times, said guide members being movable relative to said frame between an inner limit position toward said frame and an outer limit position away from said frame, said carriage also comprising a biasing member mounted to said frame and continuously biasing said guide members through the instrumentality of said linkage towards said outer limit position, wherein said carriage is adapted for self-alignment and self-centering between either one of said gates in said deployed position and the side walls of the storage area, by said guide members continuously engaging either one of said gates and the side walls of the storage area and by said linkage and said biasing member forcing said guide members to remain symmetrically disposed relative to said longitudinal axis.

4. A loading and unloading system as defined in claim 1,
further comprising a bogie, able to carry said carriage and movable along a bogie horizontal axis transverse to said carriage longitudinal axis, said bogie comprising a motor for feeding power to and moving said bogie along said bogie horizontal axis, and a platform for receiving and supporting said carriage thereon and defining two sides and front and rear end portions, wherein said bogie is destined to be movable between multiple storage areas to allow said carriage to load articles onto and unload articles from different storage areas.

5. A loading and unloading system as defined in claim 4,
wherein said guiding gates are pivotally mounted on each said side of said bogie at said bogie front end portion, said gates vertically registering with said carriage guide members and being pivotable between said retracted position in which they are pivoted towards said bogie front end portion, and said deployed position in which said gates are pivoted away from said bogie front end portion for engaging said storage area.

6. A loading and unloading system as defined in claim 5, wherein said bogie is provided with an actuator for actuating said gates between said retracted and deployed positions.

7. A loading and unloading system as defined in claim 5,
wherein said carriage further comprises a linkage pivotally attached to said carriage frame, carrying and interconnecting said guide members and forcing said guide members into an integral common displacement relative to said frame so that they remain symmetrically disposed relative to said longitudinal axis at all times, said guide members being movable relative to said frame between an inner limit position toward said frame and an outer limit position away from said frame, said carriage also comprising a biasing member mounted to said frame and continuously biasing said guide members through the instrumentality of said linkage towards said outer limit position, wherein said carriage is adapted for self-alignment and self-centering between either one of said gates in said deployed position and the side walls of the storage area, by said guide members continuously engaging either one of said gates and the side walls of the storage area and by said linkage and said biasing member forcing said guide members to remain symmetrically disposed relative to said longitudinal axis.

8. A loading and unloading system as defined in claim 7,
wherein said bogie comprises two parallel railings each fixedly attached to a corresponding said side of said bogie, said railings vertically registering with said guide members, said guide members continuously engaging said railings while said carriage is located between said railings for self-aligning and self-centering said carriage on said bogie due to said spring member and said linkage, said railings being co-extensive and substantially collinear relative to said gates when said gates are in said deployed position, for providing a continuous guiding track formed on both sides of said carriage by said railings, said gates and the storage area side walls, for continuous engagement of said carriage guide members on said guiding track when said carriage moves between said bogie and the storage area, said carriage thus being self-aligned and self-centered relative to said railings, said gates and the storage area side walls during its displacements between said bogie and the storage area during article loading and unloading operations.

9. A loading and unloading system as defined in claim 8,
wherein said guide members are idle guide wheels, with said linkage rollably carrying said idle guide wheels, wherein said carriage is adapted for self-alignment and self-centering between said railings, between said gates and between the storage area side walls by said guide wheels continuously rollably engaging same and by said linkage and said biasing member forcing said guide wheels to remain symmetrically disposed relative to said carriage frame at all times.

10. A loading and unloading system as defined in claim 1,
further comprising two anti-spill panels, each fixedly mounted atop a corresponding one of said guiding gates, for preventing articles carried on said carriage article-carrying device from tumbling off therefrom when said carriage moves between said bogie and the storage area open end.

11. A loading and unloading system as defined in claim 6, further comprising a control unit for automatically controlling the displacement of said bogie along said bogie horizontal axis, the displacement of said carriage along said longitudinal axis, and the pivotal displacement of said gates.

12. A loading and unloading system as defined in claim 11,
wherein said control unit can adjust the position of said bogie along said horizontal bogie axis when said gates are in said deployed position, according to the relative position of said gates, for selectively positioning said bogie relative to the storage area side walls.

13. A loading and unloading system as defined in claim 12,
further comprising a conveyor for conveying articles and located frontwardly of said bogie, wherein said carriage is destined to carry the articles with said article-carrying device from said conveyor into the storage area for unloading them therein.

14. A loading and unloading system as defined in claim 13, wherein said powered article-carrying device is a powered hydraulic forklift member located at said carriage front end.

15. A loading and unloading system as defined in claim 14,
wherein said conveyor is an overhead conveyor located spacedly above ground, said carriage carrying the articles being destined to move underneath said overhead conveyor and to reach the articles on the conveyor with said forklift member.

16. A loading and unloading system as defined in claim 13,
wherein said control unit further automatically controls said conveyor, for positioning the articles thereon in a precise centered relationship relative to said bogie.

17. A guiding system for use with a carriage capable of loading articles in and unloading articles from a storage area, said guiding system comprising a pair of elongated guiding gates each defining a first end having a mounting member for movably mounting said gate spacedly from the storage area, and a second free end opposite said first end, said gates being movable between a retracted position in which said second ends of said gates are destined to clear the storage area, and a deployed position in which said second ends of said gates are destined to engage an abutment member within the storage area, said guiding system further comprising a selectively powered actuator for moving said gates between said retracted and deployed positions, wherein said gates will define a path therebetween when in said deployed position for guiding the carriage to and from the storage area by the abutment of the carriage along said gates.

18. A guiding system as defined in claim 17,
wherein said mounting members are pivotable mounts, whereby said gates are pivotable between said retracted and deployed positions.
